(19) United States
(12) Patent Application Publication
(10) Pub. No.: US 2006/0249018 A1
(43) Pub. Date: Nov. 9, 2006

(54) Nucleophilic modifier functionalized and/or crosslinked solvent-resistant polymide and copolymer membranes

(76) Inventors: Hua Wang, Clifton Park, NY (US); Gary Yeager, Rexford, NY (US); Anatoli Kogan, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/121,363

(22) Filed: May 4, 2005

(51) Int. Cl. B01D 53/22

(52) U.S. Cl. 95/45

(57) ABSTRACT

A solvent-resistant polyimide membrane comprising a cross-linked polyimide homopolymer or copolymer is described. The homopolymer or the copolymer is functionalized with a nucleophilic modifier, and the membrane has suitable permeability and is resistant to solvents. In addition, a process of preparing polyimide membrane free of macrovoids is also described.

### FIELD OF THE INVENTION

This invention relates generally to solvent-resistant polyimide and copolymer membranes. In addition, this invention relates to a process of making porous polyimide membranes that contain substantially no macrovoids.

### BACKGROUND

Porous membranes include microporous flat sheets and hollow fiber membranes that can be prepared by solution-casting process or solution-spinning process. The preparation of porous membranes using a phase inversion process is known in the art. See R. Kesting, Phase-Inversion Membranes in Synthetic Polymeric Membranes—A Structural Perspective, John Wiley & Sons, 1985, pp. 237 to 286. However, microporous membranes prepared by a solution precipitation technique are generally not resistant to the solvents used to dissolve the polymer for the casting or spinning processes. These solvents, or solvents of similar strength, can dissolve or swell the polymer.

The preparation of polyimides can be found in U.S. Pat. Nos. 4,959,151, 4,474,662, and 4,978,573, and U.K. Pat. App. 2,102,333A, which are incorporated herein by reference in their entireties. These membranes are prepared from solvent solutions without any subsequent treatment to improve their solvent resistance.

U.S. Pat. Nos. 3,925,211 and 4,071,590 and Strathmann, in Desalination, Vol. 26 pages 85 (1978), incorporated herein by reference in their entireties, disclose a process for making asymmetric membranes from a film-forming prepolymer dissolved in a solvent, and converting it into a final membrane product in which the polymer is stable to solvents. These membranes can be brittle and have poor mechanical properties.

U.S. Pat. No. 4,981,497, incorporated herein by reference in its entirety, describes a cross-linking process that modifies existing polyimide membranes with amino compounds. Such modification results in lower gas permeation rates as compared to the unmodified membranes. Its application is limited to thick and dense polyimide films and requires thermal treatment in order to complete the modification.

Solvent-resistant structural composite materials can be formed by high-temperature treatment of polyamic acids to form cross-linked polyimides. However, such high-temperature treatment also tends to decrease the favorable permeability of the porous membrane by collapsing the pore structure when the membrane softens.

Membranes that are free of macrovoids are known. For example, U.S. Pat. No. 4,871,494 to Kesting et al. is related to a process of preparing asymmetric gas separation membranes having macrovoid-free morphology from a solvent system comprising a Lewis acid, Lewis base, and a Lewis acid-base complex which dissolve the hydrophobic polymers. U.S. Pat. No. 5,013,767 to Malon et al., incorporated herein by reference in its entirety, is related to a dope suitable for use in the preparation of an asymmetric, substantially macrovoid-free membrane. Other methods are disclosed in U.S. Pat. No. 6,486,240 to Won et al., U.S. Pat. App. Pub. 2001/0047959 and U.S. Pat. App. Pub. 2003/0214066.

While the art has recognized that membranes with increased resistance to solvents can be made from polyimides, it has not recognized that only a selected class of polyimides, with certain key characteristics and with a treatment step, can be made into a membrane that is both solvent-resistant and permeable. Therefore, it would be desirable for a polyimide membrane having both solvent-resistant and permeable properties.

### SUMMARY

This invention is directed to a membrane comprising a polyimide homopolymer or copolymer. The polyimide homopolymer or copolymer is functionalized or crosslinked with a nucleophilic modifier, and treated with a phase inversion process. The nucleophilic modifier is capable of reacting with the electrophilic inside group in the homopolymer or co-polymer. The polyimide membrane of this invention is resistant to solvents. The membrane is also free of macrovoids.

Illustrative examples of polyimide homopolymers or copolymers of the invention can be prepared from aromatic dianhydrides and aromatic amines. Examples of aromatic dianhydrides can be 2,2-bis(4-(3,4-dicarboxyphenoxy)phenyl)propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis([4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; -4-(2,3-dicarboxyphenoxy)-4′-(3,4-dicarboxyphenoxy)benzophenone dianhydride and 4-(2,3-dicarboxyphenoxy)-4′-(3,4-dicarboxyphenoxy)diphenyl sulfone dianhydride, as well as various mixtures thereof.

Suitable aromatic diamines can be m-phenylenediamine; p-phenylenediamine; 4,4′-diaminodiphenylpropane, 4,4′-diaminodiphenylmethane; 4,4′-diaminodiphenyl sulfide; 4,4′-diaminodiphenyl sulfone; 4,4′-diaminodiphenyl ether; 1,5-diaminonaphthalene; 3,3-dimethylbenzidine; 3,3dimethoxybenzidine; 2,4-bis(beta-amino-t-butyl)toluene; bis(p-beta-amino-t-butylphenyl)ether; bis(p-beta-methyl-o-aminophenyl)benzene; 1,3diamino-4-isopropylbenzene; 1,2-bis(3-aminopropoxy)ethane; benzidine; m-xylenediamine; and mixtures of such diamines.

The nucleophilic modifier of the membrane includes, but not limited to, an amine, sodium hydroxide, potassium hydroxide or ammonium hydroxide. In addition, the amine can be an aliphatic diamine, an aromatic diamine, an N,N-disubstituted diamineoligomeric or polymeric diamine, or a multifunctional amine, an. Examples includeN,N′-dimethylethylene diamine, N,N′-diethylethylenediamine, diethylenetriamine, 1,6-hexanediamine, α,α-xylyldiamine, N,N-dimethylethylene diamine, N,N-dimethylphenylene diamine, triethylenetetraamine, tetraethylene pentaamine, pentaethylenehexamine, polyallylamine, polyvinylamine, an α,ω-diaminopolyalkylene glycol such as α,ω-diaminopolytetrahydrofuran, α,ω-diaminopolyethylene glycol, amino terminal polysiloxane, amino functionalized thermoplastics such as amino terminated polysulfone, For example, the amine can be, polyethyleneamine, or polyamidoamine dendrimer.

As one skilled in the art will appreciate, the rate of reaction between the amino-composition and the imide-containing material will vary greatly dependent on their chemical identity and the process conditions. For pairs of amino-compositions and imide-containing materials which rapidly react with each other, the amine-modification process can include contacting the imide-containing membrane with the amino composition, either alone or as a mixture in an added component which is a nonsolvent for imide-containing membrane, followed by drying the amino-modified membrane. The membrane may be dried at elevated temperatures to complete the reaction. For pairs which react slowly or not at all under ambient conditions, the reaction may proceed at elevated temperatures. The process may be as before or the two components can be incorporated within the membrane formation procedure and allowed to react thereafter.

The phase inversion process uses an antisolvent, such as water, methanol, ethanol, isopropanol, butanol, acetone, methyl ethyl ketone or isobutyl ketone.

The membrane is resistant to a wide range of organic solvents including non-polar and polar solvents including polar aprotic solvents thus the material is resistant to hydrocarbon, ether, ketone, ester, alcohol, amide, (sulfoxide?), chlorinated hydrocarbon solvents and (water)?. For example, the membrane is resistant to solvent such as N,N-dimethylformamide, N,N-dimethylacetamide, N-methylpyrrolidinone, tetrahydrofuran, methylene chloride, chloroform, 1,1,2-trichloroethane, methanol, ethanol, isopropanol, acetone, methyl ethyl ketone, or isobutyl ketone.

The invention is also directed to a process of making a porous, solvent-resistant polyimide membrane, comprising the steps of: (a) providing a polyimide homopolymer or copolymer in an organic solvent to form a polyimide solution, (b) casting the polyimide solution into a thin film, (c) applying a phase inversion process with an antisolvent to the film to form a porous membrane, (d) treating the membrane with a solution containing a nucleophilic modifier, and (e) drying the membrane.

The process can further comprise the steps of: (f) crosslinking the membrane during step (c), and (g) heating the membrane during step (e). The heating step is carried out at about 0-150° C., preferably at about 0-80° C., more preferably at about 20-50° C.

In a different embodiment, the invention is directed to a process of making a porous, solvent-resistant polyimide membrane, comprising the steps of (a) providing a polyimide homopolymer or copolymer in first organic solvent to form a polyimide solution, (b) providing a nucleophilic modifier in second organic solvent to form a modifier solution, (c) mixing the polyimide solution with the modifier solution to form a polyimide-modifier solution, (d) casting the polyimide-modifier solution into a thin film, (e) applying a phase inversion process with an antisolvent to the film to form a porous membrane, and (f) drying the membrane.

The process can further comprise of the steps of: (g) allowing the polyimide solution and the modifier solution to undergo substantial chemical reaction after step (c), (h) crosslinking the membrane during step (e), and (g) heating the membrane during step (f).

These and other advantages and features will be more readily understood from the following detailed description of preferred embodiments of the invention that is provided in connection with the accompanying drawings.

### BRIEF DESCRIPTION OF THE DRAWINGS

FIG. 1 shows scanning electron micrographs of polyimide membranes comprising varying amounts of polyethylene glycol.

FIG. 2 shows scanning electron micrographs of polyimide membranes phase-inverted in water, methanol, isopropanol and butanol.

FIG. 3 shows scanning electron micrographs of polyimide membranes comprising varying amounts of polyethyleneimine.

FIG. 4 shows scanning electron micrographs of polyimide membranes comprising varying amounts of N,N-dimethyethylenediamine.

FIG. 5 is a scanning electron micrograph of a polyimide membrane phase-inverted from coated polyimide/amine/DMF in the aqueous solution of 20 wt % of 1,6-hexanediamine.

FIG. 6 is a flow chart depicting a method of preparing a polyimide membrane according to the invention.

FIG. 7 is a flow chart depicting a method of preparing a polyimide membrane that is macrovoid free.

### DETAILED DESCRIPTION OF PREFERRED EMBODIMENTS

This invention is related broadly to crosslinked polyimide (“PI”) membranes. Such membranes may be dense or porous membranes, symmetric or asymmetric as described in the numerous publications. The PIs useful in this invention include, but are not limited to, known PIs such as those described in U.S. Pat. Nos. 3,925,211, 4,071,590, 4,717,393, 4,474,662, 4,959,151, 4,981,497, 4,978,573, and 6,660,062, which are incorporated herein by reference in their entireties.

This invention is directed to PI membranes comprising a PI homopolymer or copolymer, wherein the homopolymer or copolymer is functionalized or crosslinked with a nucleophilic modifier. The nucleophilic modifier enhances the solvent resistance of the PI membranes. The phase inversion process with an antisolvent gives rise to a porous membrane. When the PI homopolymer or copolymer and the nucleophilic modifier are allowed to undergo substantial chemical reaction, the reaction mixture is capable of being poured and will result in membranes without macrovoids. Therefore, the PI membranes can be free of macrovoids. In yet another variation, the PI membranes can be resistant to solvent and is free of macrovoids. This invention is also directed to processes of making porous, solvent-resistant PI membranes.

These PI membranes may be dense or porous, and can be used in applications including, but not limited to, reverse osmosis, hyperfiltration, nanofiltration, ultrafiltration, microfiltration, and as support for thin film membranes, such as composite membranes.

PIs, including homopolymers or copolymers, such as polyetherimide, are a group of polymers that are useful for membrane formation because of their film forming and mechanical properties, as well as thermal resistance. PI membranes are commercially used in gas separation and as a support for composite membranes. However, inadequate solvent-resistance of amorphous PIs limits their application as fully solvent-inert membranes for the separation of organics. The PI membranes of the embodiment of the invention are broadly solvent-resistant, and the inventive process described below for making solvent-resistant PI membranes is simple and cost effective.

Illustrative examples of polyimide homopolymers or copolymers, such as those described in U.S. Pat. No. 6,822,032, incorporated by reference, can be derived from reaction of aromatic dianhydrides or aromatic tetracarboxylic acids or their derivatives capable of forming cyclic anhydrides and aromatic diamines, or chemically equivalent derivatives, to form cyclic imide linkages.

Illustrative examples of aromatic dianhydrides include, but not limited to, 2,2-bis(4-(3,4-dicarboxyphenoxy)phenyl)propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis([4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; -4-(2,3-dicarboxyphenoxy)-4′-(3,4-dicarboxyphenoxy)benzophenone dianhydride and 4-(2,3-dicarboxyphenoxy)-4′-(3,4-dicarboxyphenoxy)diphenyl sulfone dianhydride, or a mixture thereof.

Preferred dianhydrides are bisphenol-A dianhydride, benzophenone dianhydride, pyromellitic dianhydride, biphenylene dianhydride and oxy dianhydride.

Suitable aromatic diamines include, but are not limited to, m-phenylenediamine; p-phenylenediamine; 4,4′-diaminodiphenylpropane, 4,4′-diaminodiphenylmethane (commonly named 4,4′-methylenedianiline); 4,4′-diaminodiphenyl sulfide; 4,4′-diaminodiphenyl sulfone; 4,4′-diaminodiphenyl ether (commonly named 4,4′-oxydianiline); 1,5-diaminonaphthalene; 3,3-dimethylbenzidine; 3,3dimethoxybenzidine; 2,4-bis(beta-amino-t-butyl)toluene; bis(p-beta-amino-t-butylphenyl)ether; bis(p-beta-methyl-o-aminophenyl)benzene; 1,3diamino-4-isopropylbenzene; 1,2-bis(3-aminopropoxy)ethane; benzidine; m-xylenediamine; or a mixture thereof. Preferred diamines are meta- and para-phenylene diamines, diamino phenyl sulfones and oxydianiline.

The preferred polyimide resins are the polyetherimides. They are available by General Electric Plastics under the trade name ULTEM®.

Generally useful polyimide resins have an intrinsic viscosity greater than about 0.2 deciliters per gram, preferably from about 0.35 to about 1.0 deciliters per gram measured in chloroform or m-cresol at 25° C.

In a preferred embodiment, the amorphous polyimide resins of the present invention resin will have a weight average molecular weight of from about 10,000 to about 75,000 grams per mole (“g/mol”), preferably from about 10,000 to about 65,000 g/mol, more preferably from about 10,000 to about 55,000 g/mol, as measured by gel permeation chromatography, using a polystyrene standard.

PI membranes that are solvent-resistant and having suitable permeability can be formed by first using conventional solution-spinning or solution-casting processes that render the membrane microporous and highly permeable, and then converting the membrane to be highly solvent-resistant without losing its microporous morphology and thus the desirable permeability.

The modifiers to PI membranes can be selected from nucleophilic modifiers that can react with the electrophilic imide group of the PIs. Without being limited to any particular theory, suitable nucleophilic modifiers can open some of the imide functions of the PIs. When the nucleophilic modifier is an amine, the imide can open to form orthodiamide functions. When the nucleophilic modifer is an alcohol, the imide can open to form amide and ester functions. In addition, nucleophilic modifiers also include bases such as NaOH, KOH, and NR₄OH, wherein each R is independently H, C₁-C₁₀-aliphatic alkyl, C₆-C₂₀-aromatic, and C₆-C₂₀ aryl-aliphatic groups.

While mono-functional modifier can be used to functionalize the PI homopolymer or copolymer, difunctional or multifunctional reactants, such as diamines, triamines, tetraamines and polyamines, are preferred. They increase the molecular weight of PI by crosslinking. Both mono-functional and multifunctional amines render the PI membrane solvent-resistant.

Furthermore, suitable amines that can be used as modifiers include, but are not limited to, aliphatic diamines, such as 1,6-hexanediamine, or aromatic diamines, such as α,α-xylyldiamine. Preferably, the amines can be N,N-disubstituted diamines, such as N,N-dimethylethylene diamine, N,N-dimethylphenylene diamine, and N,N-diethyltheylenediamine, or other secondary diamines, such as polyethyleneamine, polyallylamine and polyvinylamine, or polyamines, such as triethylenetetraamine, tetraethylene pentaamine, and pentaethylenehexamine, or oligomeric diamines, such as α,ω-diaminopolytetrahydrofuran, α,ω-diaminopolyethylene glycol, amino terminal polysiloxanes, amino terminal polysulfones, polyimides and the like. Multifunctional amines, such as polyethylenimines, and dendrimers, such as polyamidoamine dendrimer, are also suitable for the present invention.

The amines suitable for the present invention include, but are not limited to, ammonia and various amines which in the case of polymeric amines, such as polyethyleneimine, may contain a very large number of amino groups, i.e. up to 5,000. The preferred amines are C₆-C₃₀ aromatic compounds containing 2 or 3 amino groups, or C₁-C₄₀ aliphatic compounds containing 2 to 6 amino groups.

As one skilled in the art will appreciate, the rate of reaction between the amines and the imide-containing material will vary greatly dependent on their chemical identity and the process conditions. For pairs of amino-compositions and imide-containing materials which rapidly react with each other, the amine-modification process can include contacting the imide-containing membrane with the amino composition, either alone or as a mixture in an added component which is a nonsolvent for imide-containing membrane, followed by drying the amino-modified membrane. The membrane may be dried at elevated temperatures to complete the reaction. For pairs which react slowly or not at all under ambient conditions, the reaction may proceed at elevated temperatures. The process may be as before or the two components can be incorporated within the membrane formation procedure and allowed to react thereafter.

In general, methods of making nucleophilic modifier functionalized and/or cross-linked solvent-resistant PI membranes include, but are not limited to:

(1) Casting a PI homopolymer or copolymer solution into a thin film, and subsequently crosslinking the film during the phase inversion and subsequent heating/drying steps by using solution comprising a nucleophilic modifier as coagulation agent;

(2) Pre-mixing a nucleophilic modifier solution with a solution of PI homopolymer or copolymer, and subsequently casting the PI-nucleophilic modifier solution to make a thin film by phase inversion process to produce a crosslinked membrane;

(3) Mixing a solution stream of PI homopolymer or copolymer in a solvent or solvent mixture with another solution stream of a nucleophilic modifier solution using a continuous mixing device such as a mixing-head, coating the metered liquid to the fabric support to form a thin film, and then converting the film into a porous membrane by phase inversion process to produce a crosslinked membrane;

(4) Casting a PI homopolymer or copolymer solution into a porous membrane and crosslinking the PI membrane with nucleophilic modifiers as post-treatment; and

(5) Combining methods (1) to 4) by a variety of permutations. For example, monofunctional or multifunctional nucleophilic modifiers can be premixed and reacted with PI to produce functionalized PI as in method (2), and then cross-linking the functionalized PI with difunctional or multifunctional reactive reactants in either a coagulation bath as in method (1) or by post-treatment as in method (4).

In one embodiment of this invention, the process of making a porous, solvent-resistant PI membrane involves the steps of: (a) providing a PI homopolymer or copolymer in an organic solvent, (b) casting the PI solution into a thin film, (c) applying a phase inversion process with an antisolvent to the film to form a porous membrane, (d) treating the membrane with a solution containing a nucleophilic modifier, and (e) drying the membrane.

Optionally, the process can also involve the steps of: (f) crosslinking the membrane during step (c), and (g) heating the membrane during step (e). The heating step can be carried out at about 0-150° C., preferably at about 0-80° C., more preferably at about 20-50° C.

In a different embodiment of this invention, the process of making porous, solvent-resistant PI membranes involves the steps of: (a) providing a PI homopolymer or copolymer in a first organic solvent, (b) providing a nucleophilic modifier in a second organic solvent, (c) mixing the PI solution and the modifier solution to form a mixture, (d) casting the mixture into a thin film, (e) applying a phase inversion process with an antisolvent to the film to form a porous membrane, and (f) drying the membrane.

Optionally, the process can further involve the steps of: (g) allowing the polyimide solution and the modifier solution to undergo substantial chemical reaction after step (c), (h) crosslinking the membrane during step (e), and (i) heating the membrane during step (f). Step (g) is crucial in leading to PI membranes that are macrovoid-free.

PI membranes can be fabricated into symmetric or asymmetric configurations. Asymmetric membranes may be prepared by methods including, but not limited to, phase inversion, solution coating, interfacial polymerization, plasma polymerization or sol-gel methods.

Suitable phase inversion processes include (1) vapor-induced phase separation (VIPS), also called “dry casting” or “air casting”; (2) liquid-induced phase separation (LIPS), mostly referred to as “immersion casting” or “wet casting”; and (3) thermally induced phase separation (TIPS), frequently called “melt casting”. The phase inversion process can also lead to integrally skinned asymmetric membranes. Alternatively, the porous PI can be used as a support for a thin film membrane suitably cast or interfacially polymerized onto its surface.

During the phase inversion process, PI homopolymer or copolymer is often dissolved in an organic solvent such as, but not limited to, polar aprotic solvents (e.g. N,N-dimethylformamide (“DMF”), N,N-dimethylacetamide (“DMA”), N-methylpyrrolidinone (“NMP”)), ethers (e.g. tetrahydrofuran (“THF”), chlorinated hydrocarbons (e.g. methylene chloride, chloroform, and 1,1,2-trichloroethane).

As a result of the treatment with nucleophilic modifiers, the membrane is resistant to a wide range of organic solvents including non-polar and polar solvents including polar aprotic solvents thus the material is resistant to hydrocarbon, ether, ketone, ester, alcohol, amide, sulfoxide, chlorinated hydrocarbon solvents and water. For example, the membrane is resistant to solvent such as N,N-dimethylformamide, N,N-dimethylacetamide, N-methylpyrrolidinone, tetrahydrofuran, methylene chloride, chloroform, 1,1,2-trichloroethane, methanol, ethanol, isopropanol, acetone, methyl ethyl ketone, or isobutyl ketone.

Antisolvents, such as water, alcohols (e.g. methanol, ethanol, isopropanol, butanol) or ketones (e.g. acetone, methyl ethyl ketone, isobutyl ketone), may be employed to phase invert the membrane materials. Both the organic solvents and antisolvents may be used as binary systems, or as tertiary systems by combination with other solvents, antisolvents or additives, including drying agents known to the art or polymers (e.g. polyvinylpyrrolidinone) affecting the morphology of the phase inverted membrane.

Treatment of PI with a nucleophilic modifier may occur during the phase inversion process, or just after PI has been phase-inverted to a porous membrane. The temperature of the treatment is kept at about 0-150° C., preferably at about 0-80° C. and more preferably at about 20-50° C. The treated PI may be further rinsed by organic solvent or deionized water.

Other methods of making PI membranes are well known to the art and include, but are not limited to, film stretching, template leaching, nucleation track etching, sintering, phase inversion, solution casting or extrusion.

Macrovoids are large (10-1000 micron) open cavities interspersed among the smaller pores in the substructure of a cast porous polymeric membrane.

Macrovoids are considered undesirable because they adversely affect the permeability properties and performance of polymeric membranes for microfiltration, ultrafiltration, and reverse osmosis. Frequently, the voids would create open channels or paths of least resistance through the membrane, resulting in loss of valuable products that the membrane is supposed to isolate. Consequently, membrane retention profiles were tightened to compensate for this loss, which then reduced hydraulic capacity and negatively impacted economics.

One embodiment of this invention is specifically directed to forming porous IP membranes with controlled microstructure, i.e. macrovoid-free, by using a pourable membrane-forming solution comprising PI homopolymer or copolymer, at least one solvent, and at least one nucleophilic modifier. The amount of the nucleophilic modifier in the solution is controlled so that substantial chemical reaction occurs in the membrane-forming solution, resulting in a balance of viscosity, flowability, and chain entanglement to form a substantially macrovoid-free membrane with homogeneous pore size and a high flux substantially of phase separation process.

In one variation, the PI homopolymer or copolymer is dissolved in a first organic solvent, and the nucleophilic modifier in a second organic solvent. The first and the second organic solvents are allowed to undergo substantial chemical reaction so that the membrane-formation solution becomes pourable, and the PI membrane thus formed is free of macrovoids.

The PI homopolymer, or copolymer can be dissolved in an organic solvent to form a polyimide solution. The PI is often dissolved in an organic solvent such as polar aprotic solvents (e.g. N,N-dimethylformamide (“DMF”), N,N-dimethylacetamide (“DMA”), N-methylpyrrolidinone (“NMP”)), ethers (e.g. tetrahydrofuran (“THF”), chlorinated hydrocarbons (e.g. methylene chloride, chloroform, and 1,1,2-trichloroethane), among others.

Similarly, the nucleophilic modifiers can be dissolved in one of the organic solvents to form a modifier solution. The organic solvents include, but are not limited to, polar aprotic solvents (e.g. N,N-dimethylformamide (“DMF”), N,N-dimethylacetamide (“DMA”), N-methylpyrrolidinone), ethers (e.g. tetrahydrofuran (“THF”), chlorinated hydrocarbons (e.g. methylene chloride, chloroform, and 1,1,2-trichloroethane).

Some specific applications of these PI membranes include oil refinery, such as natural gas dehydration, separation of mixtures with small boiling point differences and azeotropic mixtures. Enhancement of the aromatic content of petrochemical fuels either at the refinery or in automobiles will be beneficial. PI membranes can also be used for the removal of sulfur compounds, such as thiophene derivatives from fuels.

PI membranes can be used for a broad range of applications, including treatment of municipal and industrial waste, such as electrocoat paint recovery, oily waste water treatment, textile effluent treatments, pulp and paper effluent treatment, leather and tanning effluent treatment, abattoir effluent treatment, cheese fabrication and recovery of proteins from whey, sugar refining, concentration and deacidification of fruit juices, clarification of beverages, vegetable protein processing, egg white concentration, enzyme and microorganism separation and harvesting, bioreactor process and tissue culture systems, preparation of ultrapure water, hemofiltration, concentration of latex emulsions, recovery dewaxing aids during oil dewaxing processes, heavy oil upgrading and deaspalting, treatment of lubricating oil, edible oil processing, removal of low molecular weight monomers from polymer processes, concentration of biological macromolecules, concentration of textile sizing, concentration of heat sensitive proteins for food additives concentration of gelatin, enzyme and pharmaceutical preparations, production of ultrapure water for electronics industry, macromolecular separations (replacing the conventional change of phase methods), ultraflitration of milk, separation and concentration of biologically active components, protein harvesting, processing of water for boilers, de-watering of feedstreams, processing high-temperature feed-streams etc. In biotechnology, PI membranes can be utilized for concentration of biomass, separations of soluble products. Also, PI membranes can be used as diatomaceous earth displacement, non-sewage waste treatment for removing intractable particles in oily fluids, and aqueous wastes which contain particulate toxics and stack gas. Furthermore, PI membranes can be employed to separate solvents from pigments in paints, thus PI membranes can also be used for radioactive wastewater treatment, heavy metal recovery, recovery of organic acids from salts, pH control without adding acid or base, regeneration of ion-exchange resins with improved process design, acid recovery from etching baths, N₂ enrichment of air, low level O₂ enrichment of air, H₂ and acid gas separation from hydrocarbons, helium recovery, fuel cell membranes and supported liquid membranes.

### EXAMPLES

### Examples 1-4

### Effects of Varying Amounts of Polyethylene Glycol

Preparation of a Porous Polyimide Membrane. The polyetherimide, Ultem 6050, was obtained from GE Advanced materials. Ultem XH6050 is polymeric methylene diphenyl diisocyanate and a mixture derived from bisphenol-A dianhydride and 4,4-diaminodiphenylsulfone

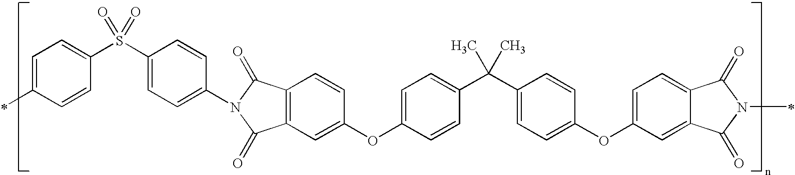

400 grams of Ultem XH6050 was dissolved in 600 grams of N,N′-dimethylformamide (“DMF”) at 140° C. and mechanically stirred to make 40% polyimide copolymer master batch solution in DMF. Afterwards, 10 grams of master batch was mixed with an appropriate amount of DMF and polyethylene glycol (“PEG”) (200 MW) to make the following solutions (see Table 1). A thin film was cast on a glass plate using a Meyer rod. The wet film was immediately quenched in solutions of deionized water, methanol, isopropanol and butanol to produce porous polyimide membranes that were air-dried.

TABLE 1
Polyimide Solution Compositions Comprising Polyimide Copolymer
and Polyethylene Glycol (PEG)

| Example | Polyimide Copolymer % | PEG % |
|---|---|---|
| 1 | 20 | 0 |
| 2 | 20 | 9 |
| 3 | 20 | 12 |
| 4 | 20 | 15 |

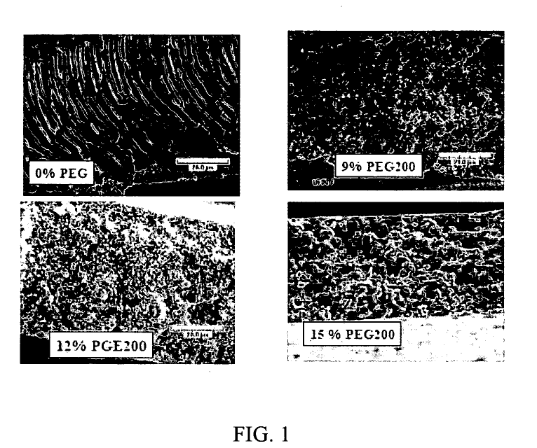

Scanning electron micrographs (SEM's) of the effects of varying amounts of PEG in the composition are shown in FIG. 1. Based on the SEM's in FIG. 1, the phase inverted polyimide membranes prepared from the solutions containing 9% and 12% of PEG showed proper porous characteristics.

The phase inverted polyimide membranes from solutions containing 9% and 12% PEG were then treated with a 20% aqueous hexanediamine solution. The untreated and treated samples were then soaked in DMF. After 24 hours, the untreated samples dissolved in the DMF, but the hexanediamine-treated samples showed no visible degradation. According to these examples, treatment with hexanediamine renders polyimide membranes solvent resistance.

### Examples 5-8

### Effects of Quenching with Different Solvents

Preparation of a Porous Polyimide Membrane: Ultem XH6050 (30 g) was dissolved in 70 g of DMF. A thin film was cast on a glass plate using a Meyer rod. The wet film was immediately quenched in solutions of (a) deionized water, with a solubility parameter of 23.4 (cal/cc) (b) methanol, with a solubility parameter of 14.5 (cal/cc) (c) isopropanol, with a solubility parameter of 11.5 (cal/cc) and (d) butanol, with a solubility parameter of 11.3 (cal/cc) to produce porous polyimide membranes that were air-dried. Solubility parameter values are based on heats of vaporization. The values obtained with this method give estimates of solution behavior. See Polymer Handbook, Eds. J. Brandrup, E. H. Immergut, and E. A. Grulke, 4^{th} Ed., John Wiley, New York, 1999, VII/675-711 for a more detailed explanation of the “d” values.

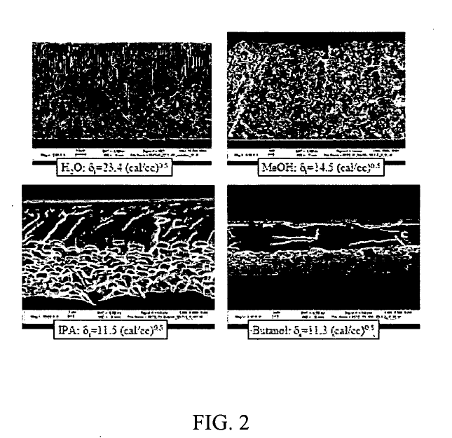

Scanning electron micrographs (SEM's) of the effects of quenching with different solvents are shown in FIG. 2. Accordingly, quenching with methanol showed proper membrane porous microstructure.

The polyimide phase inverted from water was then treated in a 20% aqueous hexanediamine solution. The untreated and treated samples were then soaked in DMF. After 24 hours, the untreated sample dissolved in the DMF, but the hexanediamine-treated sample showed no visible degradation. Accordingly, treatment with hexanediamine renders polyimide membrane solvent resistance.

### Examples 9-12

### Effects of Varying Amounts of Polyethyleneimine

Preparation of a Porous Polyimide Membrane: 400 grams of Ultem XH6050 was dissolved in 600 grams DMF at 140° C. and mechanically stirred to make 40% polymide copolymer master batch solution in DMF. Afterwards, 10 grams of master batch was mixed with an appropriate amount of DMF and 0, 0.25, 0.5, and 0.75 pph (parts per hundred of polyimide) of polyethylenimine (600 MW) and an appropriate amount of DMF to make the following solutions (see Table 2). A thin film was cast on a glass plate using a Meyer rod. The wet film was immediately quenched in solutions of deionized water, methanol, isopropanol and butanol to produce porous polyimide membranes that were air-dried.

TABLE 2
Polyimide Solution Compositions Comprising Polyimide Copymer
and Polyethyleneimine.

| | | Polyethyleneimine |
|---|---|---|
| Example | Polyimide Copolymer % | (600 MW) pph |
| 9 | 20 | 0 |
| 10 | 20 | 0.25 |
| 11 | 20 | 0.5 |
| 12 | 20 | 0.75 |

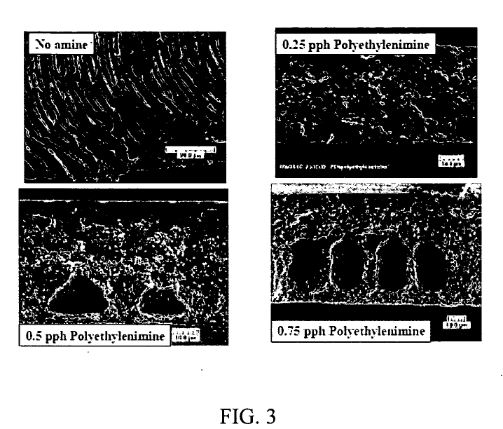

Scanning electron micrographs (SEMs) of the effects of varying amounts of polyethyleneimine are shown in FIG. 3. According to the SEM's in FIG. 3, the polyimide membrane comprising 0.25 pph of polyethyleneimine appears to be free of macrovoids. The polyimide membrane comprising 0.5 and 0.75 pph of polyethleneimine showed improved microstructure in terms of macrovoid reduction.

### Examples 13-16

### Effects of Varying Amounts of N,N′-Dimethylethylenediamine

Preparation of a Porous Polyimide Membrane: 400 grams amount of Ultem XH6050 was dissolved in 600 grams DMF at 140° C. and mechanically stirred to make 40% polyimide copolymer master batch solution in DMF. Afterwards, 10 grams of master batch was mixed with appropriate amount of DMF and 0, 0.03, 0.1, and 0.2 pph (parts per hundred of polyimide) of polyimide) of N,N′-dimethylethylenediamine and an appropriate amount of DMF to make the following solutions (see Table 3). A thin film was cast on a glass plate using a Meyer rod. The wet film was immediately quenched in solutions of deionized water, methanol, isopropanol and butanol to produce porous polyimide membranes that were air-dried.

TABLE 3
Polyimide Solution Compositions Comprising Polyimide Copolymer
and Varying Amounts of N,N′-Dimethylethylenediamine

| | | N,N′- |
|---|---|---|
| | | Dimethylethylenediamine |
| Example | Polyimide Copolymer % | pph |
| 13 | 20 | 0 |
| 14 | 20 | 0.03 |
| 15 | 20 | 0.1 |
| 16 | 20 | 0.2 |

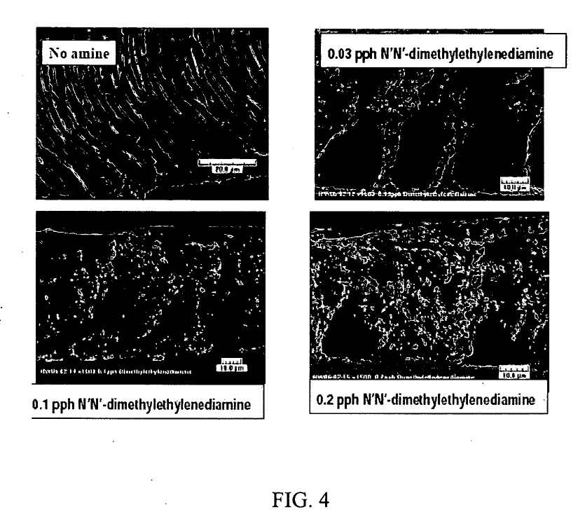

Scanning electron micrographs (SEMs) of the effects of varying amounts of N,N′-dimethylenediamine are shown in FIG. 4. According to the SEMs in FIG. 4, the polyimide membrane comprising 0.10 pph N,N′-diemthyethylenediamine is virtually free of macrovoids. The polyimide membranes comprising 0.03 pph or 0.2 pph of N,N′-diemthyethylenediamine, show improved microstructure in terms of macrovoid reduction.

### Example 17

Ultem XH6050 (30 g) was dissolved in 70 g of DMF. A thin film was cast onto a glass plate then immediately phase inverted into a water coagulation batch containing the aqueous solution of 1,6-hexanediamine (20%).

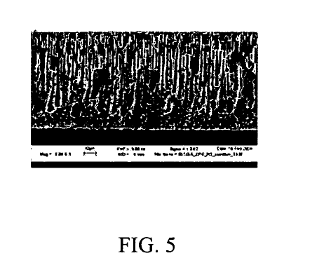

Scanning electron micrograph (SEM) of the resulting membrane is shown in FIG. 5. According to the SEM, there was no visible degradation of the polyimide membrane after soaking in DMF.

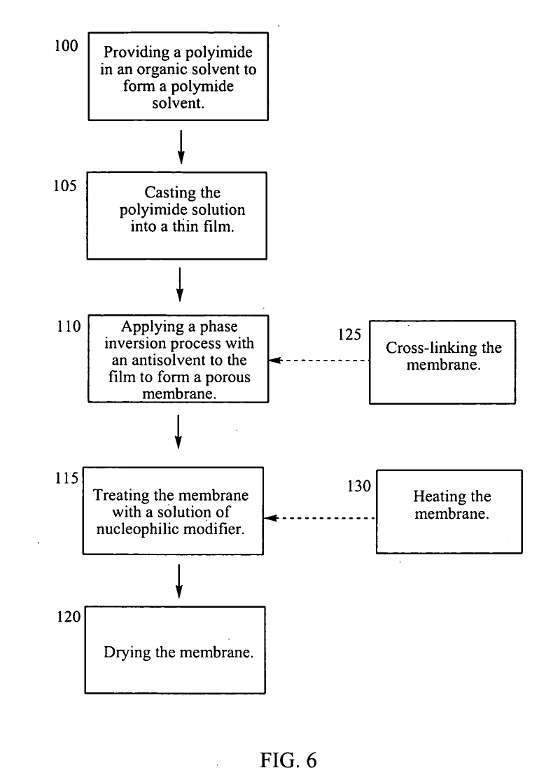

Referring to FIG. 6, a method of preparing a PI membrane according to an exemplary embodiment of the invention is shown. In step 100, a polyimide homopolymer or copolymer is dissolved in an organic solvent to form a polyimide solution. In step 105, the polyimide solution is cast into a thin film. In step 110, a phase inversion process is applied with an antisolvent to the film to form a porous membrane. In step 115, the membrane is treated with a nucleophilic modifier. In step 120, the membrane is dried. Alternatively, in step 125, a cross-linking process can be applied to the membrane during step 110. Furthermore, in step 130, heating can be applied during step 120.

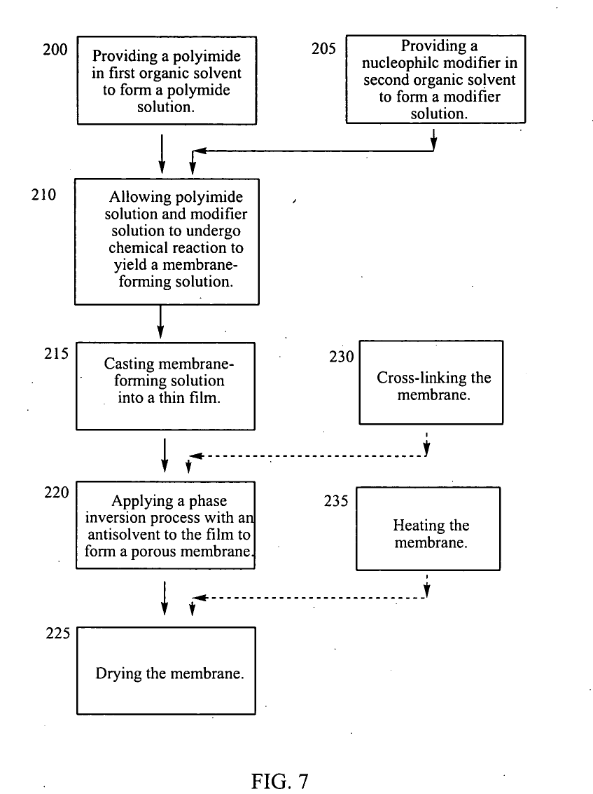

Referring to FIG. 7, a method of preparing a PI membrane that is macrovoid free according to an exemplary embodiment of the invention is shown. In step 200, a polyimide homopolymer or copolymer is dissolved in a organic solvent to form a polyimide solution. In step 205, a nucleophilic modifier is dissolved in a second organic solvent to form a modifier solution. In step 210, the polyimide solution and the modifier solution are allowed to undergo substantial chemical reaction to yield a membrane-forming solution that is pourable. In step 215, the membrane-forming solution is cast into a thin film. In step 220, a phase inversion process is applied with an antisolvent to the film to form a porous membrane. In step 225, the membrane is dried. Alternatively, in step 230, a cross-linking process can be applied to the membrane during step 220. Furthermore, in step 235, heating can be applied during step 225.

While only certain features of the invention have been illustrated and described herein, many modifications and changes will occur to those skilled in the art. It is, therefore, to be understood that the appended claims are intended to cover all such modifications and changes as fall within the true spirit of the invention.

We claim:

1. A polyimide membrane comprising a polyimide homopolymer or copolymer, wherein the homopolymer or copolymer is functionalized or crosslinked with a nucleophilic modifier, and treated with a phase inversion process, and wherein the nucleophilic modifier is capable of reacting with the electrophilic inside group in the homopolymer or copolymer.

2. The membrane of claim 1, wherein the membrane is resistant to solvent.

3. The membrane of claim 1, wherein the membrane is free of macrovoids.

4. The membrane of claim 1, wherein the homopolymer or copolymer is prepared through the condensation of an aromatic dianhydride and an aromatic amine.

5. The membrane of claim 4, wherein the aromatic dianhydride is a member selected from the group consisting of 2,2-bis(4-(3,4-dicarboxyphenoxy)phenyl)propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis([4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; -4-(2,3-dicarboxyphenoxy)-4′-(3,4-dicarboxyphenoxy)benzophenone dianhydride and 4-(2,3-dicarboxyphenoxy)-4′-(3,4-dicarboxyphenoxy)diphenyl sulfone dianhydride,

6. The membrane of claim 4, wherein the aromatic amine is selected from the group consisting of m-phenylenediamine; p-phenylenediamine; 4,4′-diaminodiphenylpropane, 4,4′-diaminodiphenylmethane; 4,4′-diaminodiphenyl sulfide; 4,4′-diaminodiphenyl sulfone; 4,4′-diaminodiphenyl ether; 1,5-diaminonaphthalene; 3,3-dimethylbenzidine; 3,3dimethoxybenzidine; 2,4-bis(beta-amino-t-butyl)toluene; bis(p-beta-amino-t-butylphenyl)ether; bis(p-beta-methyl-o-aminophenyl)benzene; 1,3diamino-4-isopropylbenzene; 1,2-bis(3-aminopropoxy)ethane; benzidine; and m-xylenediamine.

7. The membrane of claim 1, wherein the nucleophilic modifier is a member selected from an amine, sodium hydroxide, potassium hydroxide and ammonium hydroxide.

8. The membrane of claim 7, wherein the amine is a member selected from the group consisting of an aliphatic diamine, an aromatic diamine, an N,N-disubstituted diamine, a secondary diamine, an oligomeric diamine, an amino terminal polysiloxane, an amino terminal polysulfone, and a multifunctional amine.

9. The membrane of claim 7, wherein the amine is a member selected from the group consisting of 1,6-hexanediamine, α,α-xylyldiamine, N,N-dimethylethylene diamine, N,N-dimethylphenylene diamine, N,N-dimethylphenylene diamine, N,N-diethyltheylenediamine, polyethyleneamine, polyallylamine, polyvinylamine, triethylenetetraamine, tetraethylene pentaamine, pentaethylenehexamine, α,ω-diaminopolytetrahydrofuran, α,ω-diaminopolyethylene glycol, polyethylenimine, amino terminal polysiloxane, amino terminal polysulfone, polyimide and polyamidoamine dendrimer.

10. The membrane of claim 1, wherein the phase inversion process uses an antisolvent, wherein the antisolvent is a membrane selected from the group consisting of water, methanol, ethanol, isopropanol, butanol, acetone, methyl ethyl ketone and isobutyl ketone.

11. A process of making a porous, solvent-resistant polyimide membrane, comprising the steps of:
providing a polyimide homopolymer or copolymer in an organic solvent to form a polyimide solution,
casting the polyimide solution into a thin film,
applying a phase inversion process with an antisolvent to the film to form a porous membrane,
treating the membrane with a solution containing a nucleophilic modifier, and
drying the membrane.

12. The process of claim 11, wherein the antisolvent is a member selected from the group consisting of water, methanol, ethanol, isopropanol, butanol, acetone, methyl ethyl ketone, and isobutyl ketone.

13. The process of claim 11, wherein the nucleophilic modifier is an amine, sodium hydroxide, potassium hydroxide or ammonium hydroxide.

14. The process of claim 13, wherein the amine is a member selected from the group consisting of an aliphatic diamine, an aromatic diamine, an N,N-disubstituted diamine, a secondary diamine, an oligomeric diamine, an amino terminal polysiloxane, an amino terminal polysulfone, and a multifunctional amine.

15. The process of claim 13, wherein the amine is a member selected from the group consisting of 1,6-hexanediamine, α,α-xylyldiamine, N,N-dimethylethylene diamine, N,N-dimethylphenylene diamine, polyethyleneamine, α,ω-diaminopolytetrahydrofuran, α,ω-diaminopolyethylene glycol, polyethylenimine, and polyamidoamine dendrimer.

16. The process of claim 11, further comprising the steps of
crosslinking the membrane during the step of applying a phase inversion process, and
heating the membrane during the step of drying the membrane.

17. The process of claim 16, wherein the step of heating is carried out at 0-150° C.

18. The process of claim 16, wherein the step of heating is carried out at 20-50° C.

19. A process of making a porous, solvent-resistant polyimide membrane, comprising the steps of:
providing a polyimide homopolymer or copolymer in first organic solvent to form a polyimide solution,
providing a nucleophilic modifier in second organic solvent to form a modifier solution,
mixing the polyimide solution with the modifier solution to form a polyimide-modifier solution,
casting the polyimide-modifier solution into a thin film,
applying a phase inversion process with an antisolvent to the film to form a porous membrane, and
drying the membrane.

20. The process of claim 19, wherein the polyimide copolymer is polyetherimide, or bisphenol-A dianhydride and 4,4-diaminodiphenylsulfone.

21. The process of claim 19, wherein the first organic solvent is a member selected from the group consisting of N,N-dimethylformamide, N,N-dimethylacetamide, N-methylpyrrolidinone, tetrahydrofuran, methylene chloride, chloroform, and 1,1,2-trichloroethane.

22. The process of claim 19, wherein the second organic solvent is a member selected from the group consisting of N,N-dimethylformamide, N,N-dimethylacetamide, N-methylpyrrolidinone, tetrahydrofuran, methylene chloride, chloroform, and 1,1,2-trichloroethane.

23. The process of claim 19, wherein the nucleophilic modifier is an amine, sodium hydroxide, potassium hydroxide or ammonium hydroxide.

24. The process of claim 23, wherein the amine is a member selected from the group consisting of an aliphatic diamine, an aromatic diamine, an N,N-disubstituted diamine, a secondary diamine, an oligomeric diamine, an amino terminal polysiloxane, an amino terminal polysulfone, and a multifunctional amine.

25. The process of claim 23, wherein the amine is a member selected from the group consisting of 1,6-hexanediamine, α,α-xylyldiamine, N,N-dimethylethylene diamine, N,N-dimethylphenylene diamine, polyethyleneamine, α,ω-diaminopolytetrahydrofuran, α,ω-diaminopolyethylene glycol, polyethylenimine, and polyamidoamine dendrimer.

26. The process of claim 19, wherein the antisolvent is a member selected from the group consisting of water, methanol, ethanol, isopropanol, butanol, acetone, methyl ethyl ketone, and isobutyl ketone.

27. The process of claim 19, further comprising the step of
allowing the polyimide solution and the modifier solution to undergo substantial chemical reaction after the step of mixing.

28. The process of claim 19, further comprising the steps of
cross-linking the membrane during the step of applying a phase inversion process with an antisolvent to the membrane, and
heating the membrane during the step of drying the membrane.

29. The process of claim 28, wherein the step of heating is carried out at 0-150° C.

30. The process of claim 28, wherein the step of heating is carried out at 20-50° C.
